(19) United States
(12) Patent Application Publication
(10) Pub. No.: US 2026/0275799 A1
(43) Pub. Date: Sep. 17, 2026

(54) WINDOW ASSEMBLY FITTINGS AND METHOD

(71) Applicant: Elton Manufacturing, a Division of Ontario Door Sales Ltd., Mississauga (CA)

(72) Inventors: Anthonie BOER, Campbellville (CA); Sandro PIGLIAROLO, Maple (CA)

(21) Appl. No.: 19/563,653

(22) Filed: Mar. 11, 2026

Related U.S. Application Data
(60) Provisional application No. 63/772,197, filed on Mar. 14, 2025.

(51) Int. Cl. E06B 1/60; E06B 1/30; E06B 1/36

(52) U.S. Cl. CPC E06B 1/6046; E06B 1/30; E06B 1/36

(57) ABSTRACT

There is a window frame assembly for mounting a window relative to an opening in a supporting structure. It has an outer half-frame, an inner half-frame, and a glazing sheet that co-operate as an assembled full frame and window, such as may be a garage door window. The full frame has an accommodation for the glazing sheet. The glazing sheet has a span that is larger than a corresponding span of the opening in the supporting structure. The glazing sheet has a height and a width, and one or both of (a) the width; and (b) the height are greater than the height of the opening. The glazing footprint may overlap the opening in the supporting structure on all sides. The glazing sheet has accommodations formed in it to permit fasteners to pass through the glazing sheet. The glazing may be a polycarbonate sheet.

### CROSS REFERENCE TO RELATED APPLICATIONS

This application claims priority from U.S. Provisional Application No. 63/772,197, filed Mar. 14, 2025, entitled WINDOW ASSEMBLY FITTINGS AND METHOD, the contents of which are incorporated by reference herein in their entirety.

### FIELD OF THE INVENTION

This invention relates to the field of window frames having securement fittings.

### BACKGROUND OF THE INVENTION

Window assemblies may include mating inside and outside framing members, or half-frames, that mate to a wall or door penetration in a building structure, and that capture and support a glazing element, such as a window. It is helpful to install the half frames, and the glazing, with relative ease, efficiency and consistency in respect of quality. Plastic moldings are sometimes used for this purpose. They are typically secured using mechanical fasteners such as screws or bolts. However, in recent times in some locations there has been concern that the increased severity of wind-storms, hurricanes, and so on, may leave the glazing element exposed or more vulnerable to damage than may have been appreciated previously. One test for resistance to storm damage involves impact of the glazing with an air borne 2×4 stud. In each case, it may be desirable to make provision for an increase in durability of the window assembly in hope more often of surviving such occurrences.

### SUMMARY OF THE INVENTION

In an aspect of the invention, there is a window frame assembly for mounting a window relative to an opening in a supporting structure. The window frame assembly has a first half-frame, a second half-frame, and a glazing sheet. The first half-frame and second half-frame are co-operable to form a full frame. The first half frame is an outer half-frame. The second half frame is an inner half frame. The full frame has an accommodation in which to receive glazing sheet. The glazing sheet has a span that is larger than a corresponding span of the opening in the supporting structure.

In a feature of that aspect, the opening in the supporting structure has a height and a width, and the glazing sheet has a height and a width. One of (a) the width of the glazing sheet is greater than the width of the opening and (b) the height of the glazing sheet is greater than the height of the opening. In another feature, both (a) width of the glazing sheet is greater than the width of the opening and (b) height of the glazing sheet is greater than the height of the opening. In a further feature, the glazing sheet has a footprint and that footprint spans the opening in the supporting structure in at least one direction. In yet another feature, the opening in the supporting structure has a periphery. The glazing sheet has a footprint, and, as installed, the footprint extends beyond the periphery of the opening in at least two opposed locations. In still another feature, as installed, the footprint overlaps the opening in the supporting structure on all sides. In a yet further feature, the opening in the supporting structure has a periphery, and the glazing sheet has a periphery. As installed, the glazing sheet overlaps the opening in the supporting structure and all portions of the periphery of the glazing sheet lie outside the periphery of the opening in the supporting structure.

In another feature, fasteners secure the first half-frame and the second half-frame together. The glazing sheet has accommodations formed therein to permit fasteners to traverse the glazing sheet. In a further feature, the accommodations are bores made through the glazing sheet. In still another feature, the glazing sheet has a set of edge reliefs formed therein. The edge reliefs defined the accommodations for the fasteners.

In another aspect of the invention, there is a window frame assembly for mounting a window relative to an opening in a supporting structure. The window frame assembly has a first half-frame, a second half-frame, and a glazing sheet. On installation, the first half-frame and second half-frame are secured to each other by fasteners. The glazing sheet has accommodations formed therein to permit the fasteners to traverse the glazing sheet.

In a feature of that aspect, the accommodations are bores made through the glazing sheet. In another feature, the glazing sheet has a set of edge reliefs formed therein. The edge reliefs define accommodations for the fasteners. In a further feature, as installed, the glazing sheet spans the opening in the supporting structure in at least one direction. In still another feature, the glazing sheet spans the opening in at least a first direction and a second direction. The second direction is transverse to the first direction. In another feature, as installed, the glazing sheet overlaps the opening in the supporting structure on all sides. The opening in the supporting structure has a periphery. The glazing sheet overlaps all portions of the periphery of the opening in the supporting structure. In a further feature, a boundary of the glazing sheet is defined by the shortest line that circumscribes the glazing sheet and the boundary of the glazing sheet spans the opening in the supporting structure. In another feature, a boundary of the glazing sheet is defined by the shortest line that circumscribes the glazing sheet. The fasteners traverse the glazing sheet at locations inset from the boundary.

In another feature, the glazing sheet is a polycarbonate sheet. The first half-frame is an inner half-frame and the first half-frame has a peripherally extending flange that, on installation, engages an inner face of the supporting structure and a peripheral web that extends at least part way through the supporting structure away from peripherally extending flange toward second half-frame. The second half-frame is an outer half frame that has a peripherally extending flange that, on installation, engages an external face of the supporting structure. The accommodations lie inwardly of the peripheral web. The fasteners traverse the glazing sheet inwardly of the peripheral web. The glazing has a circumscribed boundary that lies outside the peripheral web.

In another aspect of the invention there is a window frame assembly for installation in an opening in a supporting structure. It has a first half-frame, a second half frame, and a spanning sheet. The first half-frame is an outside half frame. The second half frame is a mating inside half-frame. The first half-frame and the second half frame are mutually co-operable on installation to define a full frame. The spanning sheet is at least partially translucent. There is an accommodation in the full frame in which, on assembly, the spanning sheet is captured by the outside half frame. The inside half frame defining a retaining periphery sized to fit within the supporting structure. The spanning sheet is larger than the retaining periphery. The first half-frame and second half-frame are secured to each other inwardly of the retaining periphery.

In a feature of that aspect of the invention, the spanning sheet is transparent. In another feature, the full frame includes at least a first frame index that lies within the retaining periphery and the spanning sheet has at least a first sheet index. The first frame index and the first sheet index are mutually engaging to inhibit release of the spanning sheet. In another feature, the outside half frame has at least a first protrusion defining the first index. In a further feature, the first protrusion is a first attachment boss and, on installation fastening hardware engages the boss to secure the inside half frame to the outside half frame. Instill another feature, the outside half frame has a set of protrusions extending therefrom toward the inside half frame. The spanning sheet has a corresponding set of allowances formed therein. The allowances seat on the protrusions on installation of the spanning sheet. In another feature, the spanning sheet has a thickness, tₛₕₑₑₜ. and the protrusions have a length that is greater than tₛₕₑₑₜ. In a further feature,
the set of protrusions define attachment bosses that, on assembly, receive fastening hardware to secure the inside half frame in position relative to the outside half frame.

In still another feature, the inside half frame includes a peripherally extending formed channel section having toes facing toward the outside half frame. The toes include an outer peripheral toe and an inner peripheral toe. On installation, the outside half frame has at least one index that locates between the inner peripheral toe and the outer peripheral toe. In a further feature, the outside half frame has a set of protrusions that define the index. The protrusions extend from the outside half frame toward the inside half frame. The protrusions define attachment bosses that, on installation, are engaged by fastening hardware that secures the outside half frame in position relative to the inside half-frame. As installed, the attachment bosses have tips that register within the formed channel section. In a further additional feature the channel section has a back, and, on installation, the fastening hardware works against the back of the channel to urge the outside half frame and the inside half frame toward each other. In another feature, the outside half frame has a set of protrusions upon which the spanning sheet seats, the protrusions have a length, L, and the spanning sheet has a thickness tₛₕₑₑₜ that satisfies the condition tₛₕₑₑₜ≤½ L. In a further feature, the spanning sheet has a thickness that is in the range of 3/16″ to 5/16″.

In another feature, the inner half frame has a pair of opposed first abutment flange portions that, on installation, bear against an inside face of the supporting structure. There is a pair of opposed insertion flange portions that locates within the opening in the supporting structure. The flange portions extend from the respective abutment flange portions of the inner half frame toward the outside half frame. There is a first span dimension defined across the pair of opposed insertion flange portions. The spanning sheet spans at least the first span dimension. In a further feature, the inner half frame has a second pair of opposed insertion flange portions. There is a second span dimension defined across the second pair of opposed insertion flange portions. The second span dimension extends in a direction transverse to the first span dimension. The spanning sheet also spans the second span dimension. In another feature the spanning sheet has length and width dimensions that exceed the respective first and second dimensions by an amount in the range of ¾″ to 1-¼″ on all sides.

In a further feature, the outside half-frame includes a surround having a periphery that lies fully outside the retaining periphery. The outside surround defining a trim molding of the outside half-frame and that, in use, bears against an outside of the supporting structure to which the window frame assembly is mounted. In still another feature, the outside half-frame has a boundary portion of a first thickness and a spanwise extending portion extending inwardly from the boundary portion. The spanwise extending portion has a second thickness. The second thickness is less than the first thickness such that a recess is defined laterally inwardly of the boundary portion. The spanning sheet is sized to seat in the recess. The spanning sheet has a through-thickness. The recess has a depth corresponding to the through thickness of the spanning sheet. In an further feature, the spanning sheet is a polymeric sheet. In a still further feature, the spanning sheet is a polycarbonate thermoplastic.

In another aspect of the invention there is any combination of any of the features of any one of embodiments shown or described herein, in combination with the features of any other embodiment, except to the extent those features are mutually exclusive. In another aspect of the invention, there is any apparatus substantially as shown or described herein, in whole or in part.

### BRIEF DESCRIPTION OF THE DRAWINGS

These aspects and other features of the invention can be understood with the aid of the following illustrations of a number of exemplary, and non-limiting, embodiments of the principles of the invention in which:

FIG. 1a shows a perspective exploded general assembly view of a window frame assembly;

FIG. 1b shows a front view of the window frame assembly of FIG. 1a;

FIG. 1c shows a longitudinal section of the window frame assembly of FIG. 1b on section ‘1c-1c’;

FIG. 1d shows a transverse section of the window frame assembly of FIG. 1b on section ‘1d-1d’;

FIG. 2 shows an enlarged corner detail ‘2’ noted in FIG. 1c looking on the longitudinal section in the transverse direction;

FIG. 3 shows an enlarged corner detail ‘3’ noted in FIG. 1d looking on the transverse section in the longitudinal direction;

FIG. 4a is an isometric view of the outside of an outer frame half of the widow frame assembly of FIG. 1a;

FIG. 4b is an inside plan view of the outer frame half of FIG. 4a looking outward;

FIG. 4c is a side view of the outer frame half of FIG. 4a on a long side thereof;

FIG. 4c is a side view of the outer frame half of FIG. 4a on a short side thereof;

FIG. 4e is a view taken on longitudinal section ‘4e-4e’of FIG. 4b;

FIG. 4f is a view taken on transverse section ‘4f-4f’of FIG. 4b;

FIG. 5a is an isometric view of the inside of an outer frame half of the widow frame assembly of FIG. 1a;

FIG. 5b is an inside plan view of the outer frame half of FIG. 5a;

FIG. 5c is a long side view of the outer frame half of FIG. 5a;

FIG. 5d is a short side view of the outer frame half of FIG. 5a;

FIG. 5e is a view taken on longitudinal section ‘5e-5e’of FIG. 5b;

FIG. 5f is a view taken on transverse section ‘5f-5f’of FIG. 5b;

FIG. 6a is a plan view of a spanning sheet of the window frame assembly of FIG. 1a;

FIG. 6b is a longitudinal side view of the spanning sheet of FIG. 6a;

FIG. 6c is a transverse view of the spanning sheet of FIG. 6a.

FIG. 7 is a plan view of an alternate spanning sheet to that of FIG. 6a.

### DETAILED DESCRIPTION

The description that follows, and the embodiments described therein, are provided by way of illustration of an example, or examples, of particular embodiments of the principles of the present invention. These examples are provided for the purposes of explanation, and not of limitation, of those principles and of the invention. In the description, like parts are marked throughout the specification and the drawings with the same respective reference numerals. The drawings may be understood to be to scale and in proportion unless otherwise noted. The wording used herein is intended to include both singular and plural where such would be understood, and to include synonyms or analogous terminology to the terminology used, and to include equivalents thereof in English or in any language into which this specification may be translated, without being limited to specific words or phrases.

This description pertains to window frame assemblies. In that context, window frame assemblies are most typically installed in supporting structural assemblies, most generally doors or wall assemblies. In North America a typical entrance door assembly is about 1-¾″ to 2-¼″ thick and may include a steel door frame. The steel door frame may typically have a hollow steel skin which may be about 0.020″ thick, but may be up to about 0.050 thick, filled with substantially rigid foam thermal insulation. A typical garage door may be 1″ to 2″ thick, and may have a metal skin thickness of 0.030″ to 0.050″. A typical wall assembly includes framing; a form of inside wall sheeting; and a form of outside wall sheeting. While other materials can be, and are, used, most traditionally the framing may have the form of 2×4 studs, or more commonly now, 2×6 studs with an internal vapor barrier and internal sheeting such as ¾″ thk×4 ft×8 ft drywall gypsum board, e.g., “Gyproc” (t.m.). The windows will have been sized beforehand, and whether in a steel door or in a different kind of framing, the opening in the framing will be sized to receive the window and the window jambs, sills, and sashes, as may be. Without limiting the generality of applicability of the principles of the apparatus, in this specification the assembly may be taken as a garage door window installation.

For the purposes of this description, it may be that a Cartesian frame of reference may be employed. In such a frame of reference, the long, or largest, dimension of an object may be considered to extend in the direction of the x-axis, the base of the article, where substantially planar, may be considered to extend in an x-y plane, and the cross-wise or transverse dimension of the article may be measured in the transverse, or y-direction. Accordingly, the width of the window assembly described herein may be arbitrarily designated as the x-direction; and the height may be arbitrarily designated as the y-direction. The through-thickness is then the z-direction. In the context of window frame assemblies, the window frame assemblies are typically rectangular, although they could be square, or round, or triangular, or some other shape. For simplicity of explanation, discussion will proceed on the basis of the window assembly being rectangular, like a picture frame, while realizing that other shapes are possible.

The long, or x-dimension, or x-direction, may sometimes be the vertical direction when installed, and the transverse direction, or y-dimension or y-direction is take to be the width direction of the window frame, with the x-direction and y-direction generally lying in the same plane as, or a parallel plane to, the wall structure in which, or to which, the window assembly is to be mounted. In the context of a garage door window assembly, the long direction is typically the y-direction, and the short direction is the x-direction. While the long dimension is usually the vertical dimension, it may be the horizontal direction in some cases, as in casement windows. Again, for simplicity of explanation it will be taken that that other possibilities exist.

Unless noted otherwise, the terms “inside” and “outside”, “inwardly” and “outwardly”, refer to location or orientation relative to the window in the through-thickness context. However, in respect of the periphery or boundary of an opening or sheet, the terms “overlapping”, “inwardly” and “outwardly” are understood in the context of lying in the plane or surface of the periphery or boundary of the spanning sheet, or glazing, or opening, or wall structure as lying within the area circumscribed by the periphery or boundary, or, conversely, outside that area. In this specification, the commonly used engineering terms “proud”, “flush” and “shy” may be used to denote items that, respectively, protrude beyond an adjacent element, are level with an adjacent element, or do not extend as far as an adjacent element, the terms corresponding conceptually to the conditions of “greater than”, “equal to” and “less than”. When reference if made to the periphery of the opening, or of a half-frame member or a pane of glazing, or a spanning sheet, the terms “outwardly” and “inwardly” relative to the periphery are terms that are understood to be taken in the plane of the opening, or frame, or sheet, as opposed to the through-thickness direction of the window as installed.

It may also be that while windows are most often desired to be transparent (so that the glazing permits specular transmission of light), some windows-such as washroom, door, sidelight, or transom windows-may desirably not be transparent. Rather they may be “frosted”, i.e., translucent while not being transparent (so that they permit only diffuse transmission of light). The term glazing, or a pane of glazing, is intended to be generic in this context, whether translucent or merely diffusely transparent.

Referring to the Figures, in a general overview, a window assembly is indicated as 20. Window assembly 20 may be a window in a supporting structure 18, be it a door, a wall or other structure as may be. Window assembly 20 may include a first, or inside, surround, or bezel, or frame, or half frame 22; a second, or outside, surround, or bezel, or frame, or half frame 24; and a panel or panel assembly 26 carried by, and typically bracketed by, or sandwiched by, the inside and outside assemblies 22, 24. When assembled on installation, the inside half frame and the outside half frame co-operate to define a full frame. That full frame captures panel assembly 26 in position. When the sandwich is formed, the inside frame 22 and the outside frame 24 may be held in place with one or more securement fittings 40. In the example shown, the securement fittings may have, include, or co-operate with fastening hardware 42. Alternatively, the securement fittings may include molded plastic fittings, such as male and female clips, such as bayonet fittings, and so on, that permit one-way insertion and that mutually engage and prevent subsequent separation. Such plastic clips may be formed as part of the window half-frame moldings themselves, or may be supplied separately. The fastening hardware may be, and in the example illustrated is, in the form of threaded fasteners that are tightened on installation to secure the assembly in place in the opening in the framing in the wall structure.

In the most generic sense, panel assembly 26 may be any kind of panel. However, in the context of the present invention, panel assembly 26 may typically have the form of a planar, or substantially planar sheet, and may most typically be, or include glazing such as may be identified generically as a window pane or glazing panel or glazing sheet, whether clear (i.e., transparent) or frosted (translucent); whether sealed or unsealed; whether plain or patterned or coloured or decorative in the form of a stained glass assembly or similar.

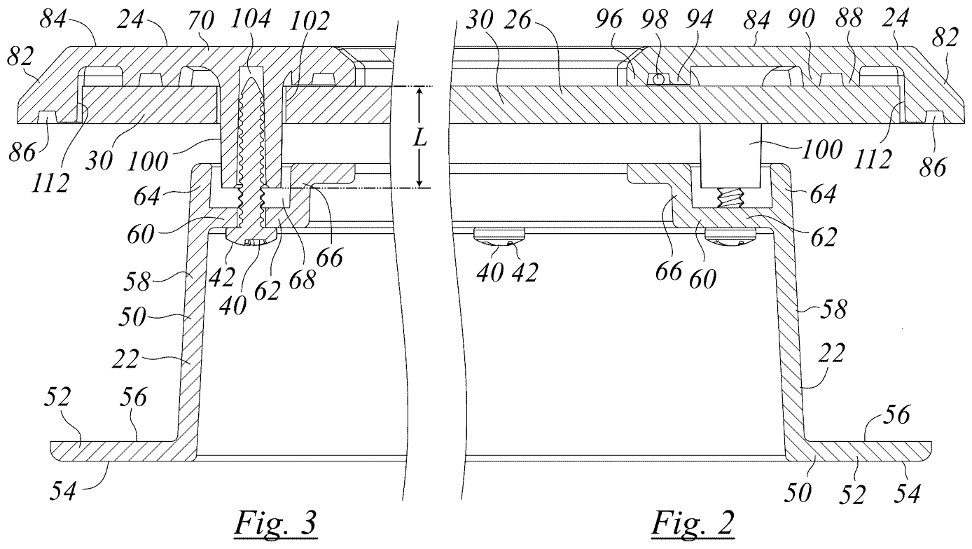

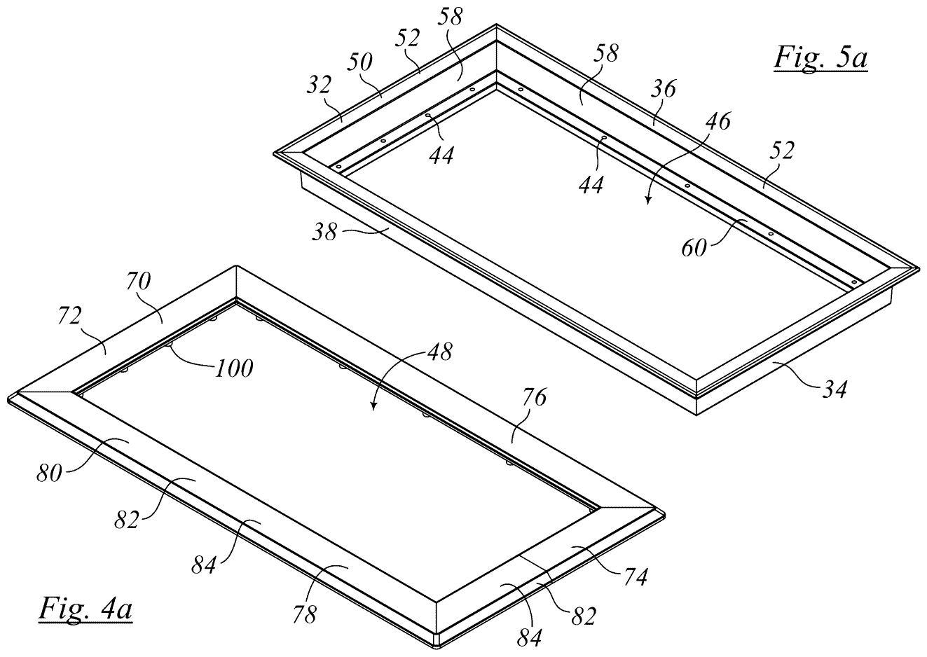

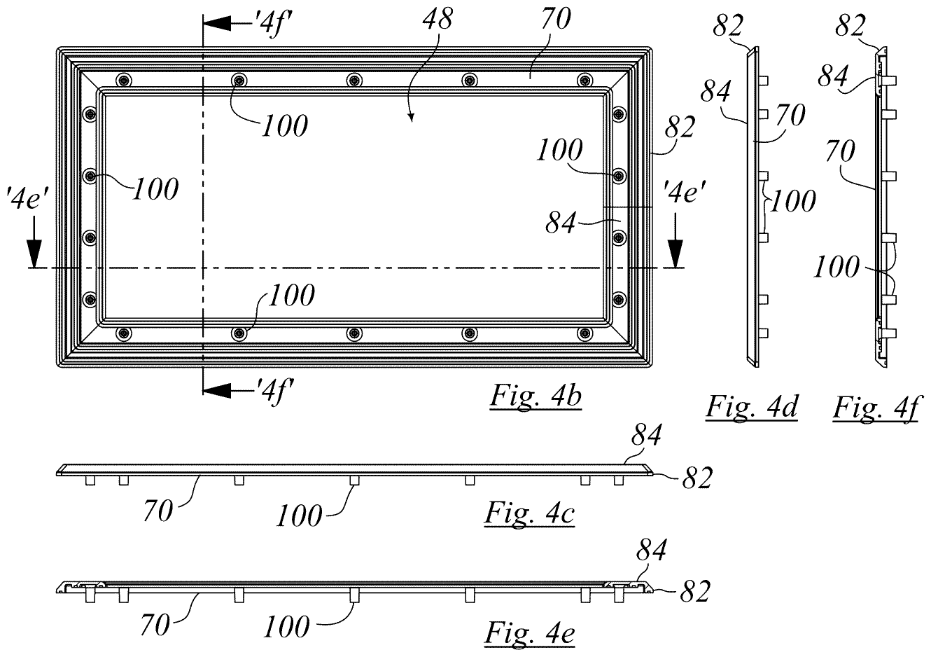

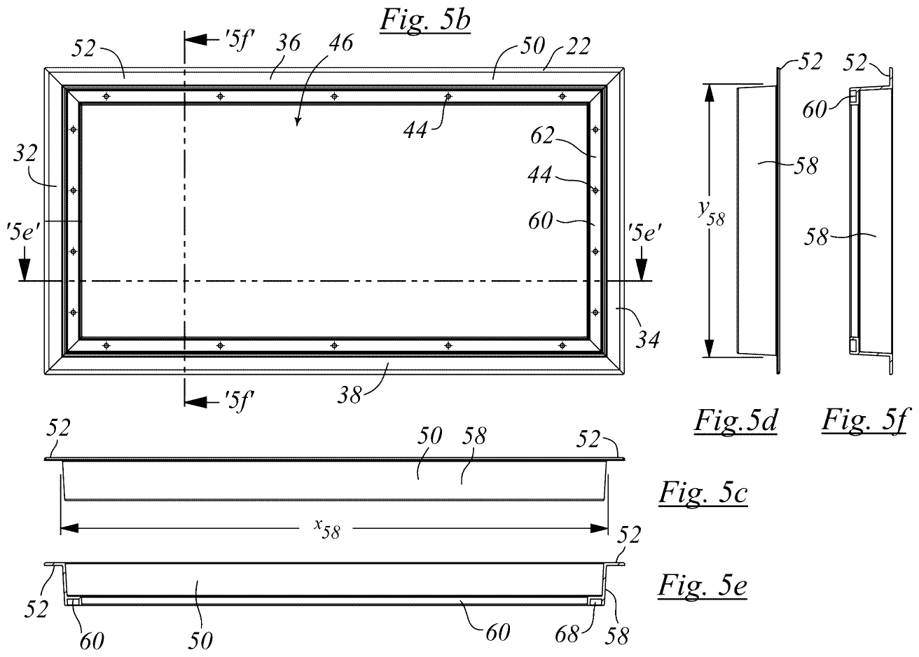

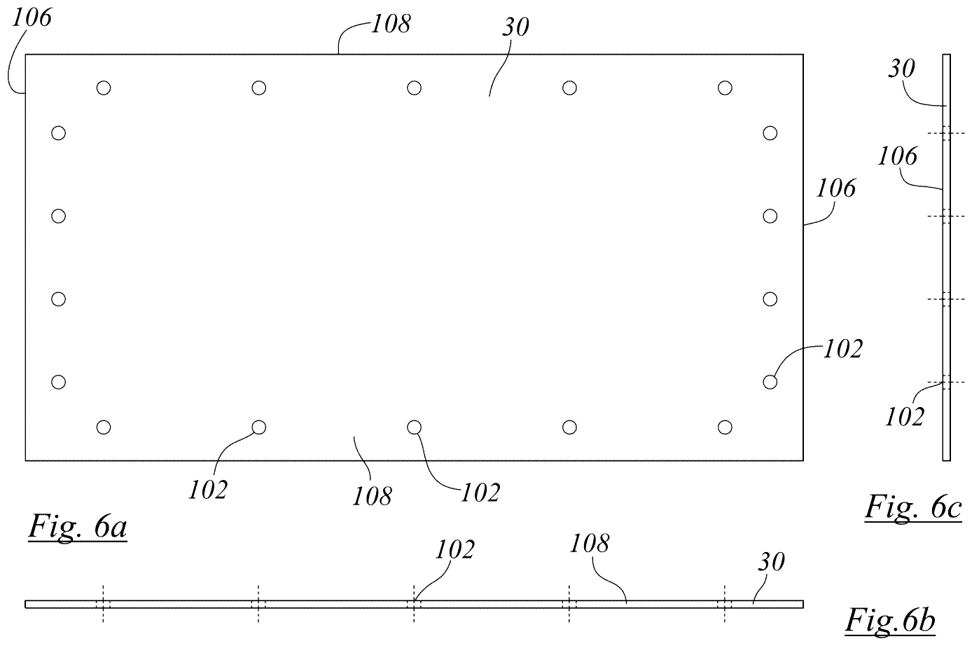

While round, or oval, or triangular or trapezoidal planform window shapes are known, for the purposes of the simplicity of this description, and in most common use, window assembly 20 and panel assembly 26 in particular may be taken as being four-sided, most typically rectangular panel elements. As with the opening in the supporting wall structure, often, though not always, the rectangular form may have a long dimension that is the vertical dimension on installation, corresponding to the x-axis or x-direction in this description. Window assembly 20 and panel assembly 26 may also have a shorter dimension that may be the width dimension on installation running in the y-axis or y-direction. The entire assembly may have a through thickness in the z-direction. The entire window assembly may be predominantly or substantially planar in the sense that the x-direction and y-direction extent of the structure may typically be many times the through-thickness dimension in the z-direction. The entire assembly may be mounted in surrounding structure, suggested by the intermittent dashed lines of supporting structure 18 in FIGS. 2 and 3, which, in this instance may be taken to be a steel door frame, although it could be a wall, or even a roof in the context of a skylight.

For the purposes of this description, panel assembly 26 will be considered to include transparent glazing. The transparent panel or glazing sheet may be identified as spanning sheet 30. Spanning sheet 30 has a thickness tₛₕₑₑₜ. In this description, sheet 30 is the outer facing layer, or panel, or stratum, of the assembly through which light may pass. The panel could be made of glass. Whether transparent or frosted, it could be toughened glass, laminated glass, or safety glass, such as used in automobiles. It may be wired glass. It may be a non-vitreous form of glazing, such as one or more layers of a translucent or transparent polymer, or combination of polymers, as may be. In one example, the glazing panel can be understood to be a non-vitreous layer. More particularly, sheet 30 may be, and in the illustration shown is, a non-fracturing material. To that end, sheet 30 as illustrated may be a polymeric material, of however many layers. That polymeric material may be a polycarbonate sheet. That polycarbonate sheet may be a transparent thermoplastic sheet made of a polycarbonate resin. One example of a brand of such sheeting is sold under the name “Lexan”, a trade mark of Sabic Global Technologies, B.V. The through-thickness of the polymeric sheet is comparable to the through-thickness. The thickness of the polymeric sheet may typically be in the range of 3/16″ to 5/16″ and may be ¼″.

Item 22 or 24 may be referred to individually as a “frame”, or they may be referred to as a “half-frame” in the sense of being either the inside or the outside half of the overall window frame assembly 20 more generally. The respective outwardly facing surfaces of frames, or half-frames 22 and 24 need not be the same in external profile or appearance. However, for the purpose of this description it may be convenient that they be the same or similar.

Inside half-frames 22 has a first portion 32, a second portion 34, a third portion 36 and a fourth portion 38, co-operating to form a rectangle with an open center, the opening being identified as opening 46. The molding is accordingly “a surround”, i.e., an open frame that surrounds a glazing panel. First portion 32 may also be referred to as a first cross-member such as bottom sill member. The second portion 34 may also be referred to as a second cross-member in the form of an upper cross-member or sash. The third portion 36 may also be referred to as a first side member, or first upright, or first jamb extending between members 32 and 34. The fourth portion 38 may also be referred to as a second side member, or second upright, or second jamb, that is spaced apart from and opposed to first jamb 36. The elements of the assembly, namely portions 32, 34, 36 and 38, may all have the same cross-sectional profile details as illustrated in FIGS. 2 and 3, such as will be described hereinbelow.

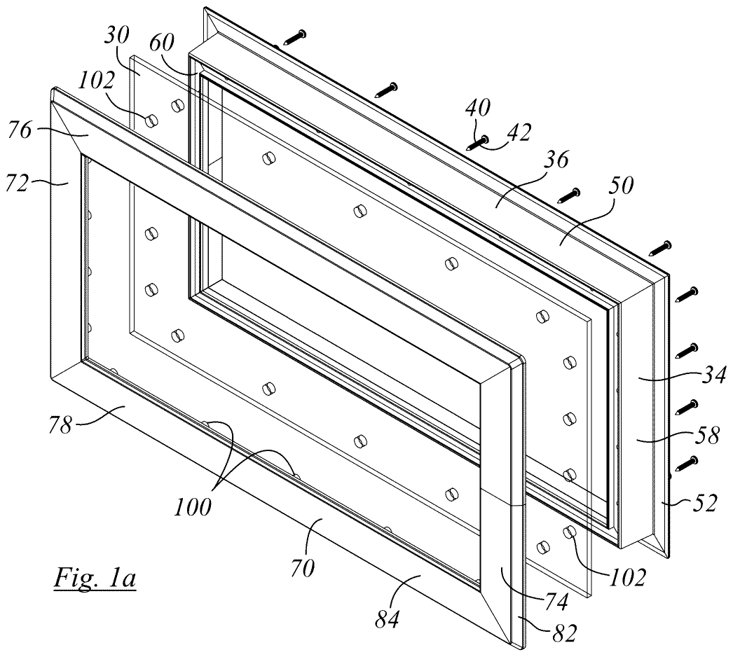

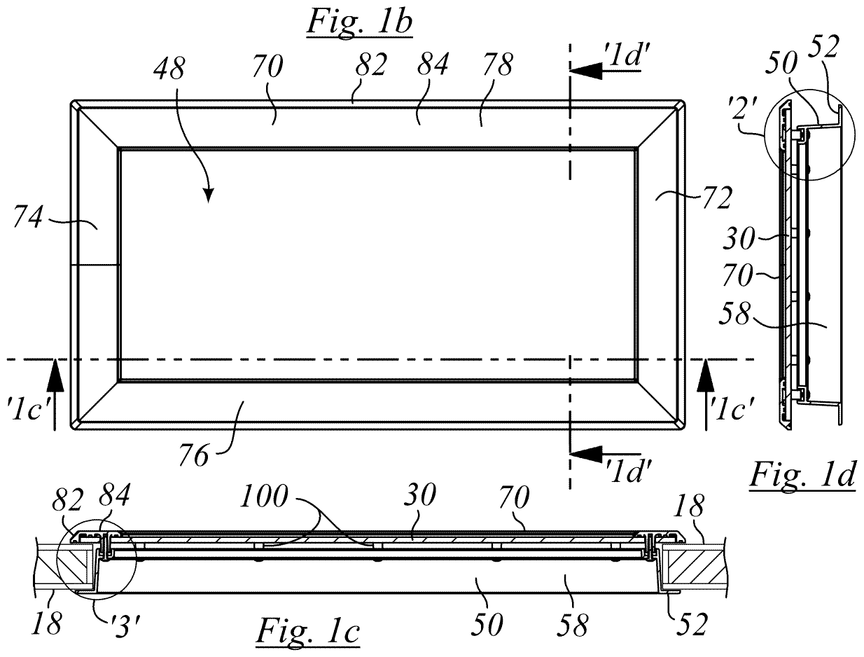

Each of half-frames 22, 24 is formed as a single piece molding. Although the moldings could be made of aluminum, they are typically made of plastic, which may be PVC, PC/ABS or PP (polypropylene). FIG. 2 shows the cross-section taken across the short side of FIG. 1c on enlarged detail ‘2’. FIG. 3 shows the cross-section taken across the long side of FIG. 1d on enlarged detail ‘3’. The molding of inside half-frame 22 is identified generally as 50. It has a first portion, or first item, or first wall, or member, or flange, 52 that can be thought of as the external facing or fascia of molding 50. That is, as installed the visible surface 54 of member 52 faces away from the window pane into the room of the building, and provides the presentation surface most visible to persons facing the window, and, as such is “the fascia” of the interior face. It can be considered, and is, a “trim panel”, or simply trim, which may have or define an arbitrary decorative appearance, or to which an arbitrary decorative appearance, or a coating such as paint, may be applied. The back side 56 of flange 52 defines an abutment surface that, as installed, bears against the face of the inside of the supporting wall structure. Most typically, inside face 56 may be expected to bear against drywall. Member 52 functions as a peripheral flange of half frame 22 that lies in a plane parallel to the plane of the glazing, i.e., an x-y plane. Inasmuch as flange 52 extends fully about the periphery of molding 50, on installation flange 52 will conceal the rough or unfinished edges of the opening in the framing of the supporting structure 18, and so flange 52 may also be referred to as a “conceal”. It has both the esthetic function of concealing rough edges, and the structural function of forming an abutment or shoulder, or stop that bears against the outside face of the supporting structure.

Molding 50 also has a forwardly extending leg 58. Leg 58 forms an angle with flange 52. Leg 58 may not necessarily form a right-angle relative to flange 52, but may rather be slightly tapered such that the taper forms a lead-in to facilitate installation in the opening, or socket, defined by the window framing of supporting structure 18, i.e., like the shank or body of a plug. In effect, inwardly extending leg 58 forms a continuous peripheral web relative to flange 52, and, as such, may encourage flange 52 to remain planar.

At the innermost end of leg 58 there is a formed channel section 60. It has a back 62 extending peripherally inwardly of leg 58 to form a ledge or shoulder around the inside of the glazing. Channel section 60 has four respective short and long side portions of the rectangle formed by first, second, third and fourth potions 32, 34, 36 and 38 of inside half frame member 22, such that channel section 60 extends fully about the periphery of opening 46. Channel section 60 has a pair of toes 64, 66. First toes 64 is end of leg 58 extending toward outside half frame 24. Second toe 66 is joined to back 62 and is spaced apart from, and in opposition to, first toe 64 there is a space or accommodation 68 in the three-sided channel section bounded on three sides by back 62 and legs 64, 66. Apertures 44 are formed in back 62 to receive fastening hardware 42. Apertures 44 are spaced about the periphery of channel section 60. In an alternate embodiment, there is not a channel section, but rather a flat flange corresponding to back 62. The end of leg 66 may be bent outward away from accommodation 68 in a further toe as illustrated to form a flat that faces the glazing and conceals the seal.

Outside frame 24 is made of a molding 70. Like molding 50, molding 70 may have a set of four sides, being two short sides 72, 74 and two long side 76, 78, the short sides and long sides being mutually opposed, respectively, to form a rectangle that extends peripherally about opening 48 in molding 70. Looking at molding 70 in cross-section in FIGS. 2 and 3, there is an outer portion or leg 82, and a rather longer peripherally inwardly extending portion or leg 84. As may be understood, the overall x and y dimensions of molding 70 are roughly comparable to, or perhaps slightly larger than, the overall x and y direction dimensions of inner flange 52 of inside half frame 22. Leg 82 may include a relief 86 that may, on assembly, accommodate an O-ring seal, or a bead of caulking such as clear silicone caulking or a hot melt glue or adhesive. The inner portion, or inner leg 84 extends inwardly of the periphery a distance greater than the distance of leg 66 from the tip of flange 52. This means that the inside edge of inside half-frame 22 will be hidden from view from the outside on installation. The outside, i.e., visible, face 80 of molding 70 is the externally visible finished trim face of the assembly and may have a color included in the plastic resin or may be painted or otherwise coated to yield a commercially acceptable finish appearance.

The inside face of molding 70 has a pair of internally protruding ribs 88, 90 close to leg 82 that bear upon the outer edge of spanning sheet 30 on installation. Whereas the inside face 110 of leg 82 provides the closing edge or peripheral flange of molding 70, generally, ribs 88, 90 have a protrusion height that is stepped back from the inside facing surface 92 of leg 82 that bears against the supporting wall structure. That is, molding 70 has a first thickness, namely the extent of leg 82 from face 86 to surface 92; and a second thickness, namely the offset through thickness from face 86 to the tips of ribs 88, 90. The second thickness is less than the first thickness by an amount that can be identified as the recess height.

As seen in FIGS. 2 and 3, this recess height corresponds to the through-thickness of spanning sheet 30. Spanning sheet 30 seats in the recess, or rebate, or accommodation 112 so formed while first portion 82 conceals the edge of spanning sheet 30 from view, and, if an O-ring or bead of sealant or caulk, or hot melt adhesive is used, portion 82 seals window assembly 20 against the support structure 18 to discourage the ingress of water during rain storms. Where adhesive is used, it also affixes the spanning sheet to the window frame. In this context, too, the inside faces 110 of legs 82 of short sides 72, 74 and long sides 76, 78 define index members that locate spanning sheet 30. That is, inside faces 110 combine to form a four-sided socket into which the corresponding mating index members defined by short and long sides 106, 108 of spanning sheet 30 fit. As so seated, the respective indexing features are opposed and spanning sheet 30 is fixed in position relative to outer half-frame 24.

Similarly, peripherally inwardly of ribs 88, 90 there is another pair of ribs 94, 96 with a seal ring rebate 98 between them. Ribs 92, 94 are of comparable height to ribs 88, 90. On installation they also bear on spanning sheet 30 with rib 92 being roughly in line with leg 66 of channel section 60. Again, if an O-ring seal or a bead of caulking is placed in rebate 98, a seal will be formed on assembly such as may tend to discourage the ingress of water.

Outside half frame 24 also has a set of protrusions 100 spaced around the periphery. Protrusions 100 may have the form of bosses that extend inwardly in the z-direction away from face 86 toward inner half frame 22. Those bosses may be hollow bosses, or sockets, as shown in section in FIG. 2. On assembly, the blind bores 104 of protrusions 100 define hollow sockets may receive the fastening hardware that secures inner half frame 22 and outer half frame 24 together on assembly. As may be noted, the lateral spacing between opposed ones of protrusions 100 in the x-direction and in the y-direction define a boundary, or perimeter 110, or space envelope that retains, and constrains, the glazing pane to sit in one place. As understood, bosses 100 form a containment array in which the glazing pane is then captured on installation. Notably, the height, or length, L, of the bosses defined by protrusions 100 inwardly proud of leg 84 is greater than the through thicknesses of spanning sheet 30, and yet the amount by which bosses 100 exceed that combined height, or combined thickness, is less than the clearance height inside channel section 60. As may be noted, spanning sheet 30 has an array of accommodation, or reliefs, or seats, or aperture 102 that are inset from respective short side and long side edges 106, 108 of spanning sheet 30. Apertures 102 are arrayed on spacings that correspond to the spacing of the array of bosses 100, such that each boss 100 may seat within a respective aperture 102. The fit of apertures 102 on bosses 100 may be a relatively loose fit with a clearance dimension tolerance, i.e., apertures 102 are intended to be clearance holes.

On assembly, the inwardmost ends, or tips, of bosses 100 may register in the space defined by accommodation 68 of channel section 60. Tightening of fastening hardware 42 draws the half frames 22, 24 together to seat on the respective inner and outer faces of supporting wall structure 18 and in so doing further immobilizes spanning sheet 30 within accommodation 112, and secures the entire assembly in place in the supporting structure. Given that spanning sheet 30 is larger than the inside clearance dimension between opposite portions of leg 64, and so therefore larger than the opening in the supporting structure, spanning sheet 30 cannot be drawn through the window opening. Moreover, spanning sheet 30 spans both the x and y dimensions of the opening in the supporting wall structure, as represented by the overall outside x and y dimensions x₅₈ and y₅₈ of peripherally extending leg 58 adjacent to flange 52 of molding 50. Thus, if impact is made to sheet 30, that impact is carried to the supporting wall structure, and distributed into that structure. Sheet 30 is larger than the opening in supporting structure 18, for which the outside measures x₅₈ and y₅₈ of window assembly 20 are proxies for the inside x and y dimensions of the opening in supporting structure 18. Those dimensions are taken over the respective opposed pairs of side portions defined by the portions of inwardly extending flange 52 in the x and y-directions, the directions being transverse to one another. Inasmuch as spanning sheet 30 is made of a polymeric resin, it may tend to be more resistant to impact damage than a vitreous member. Being larger than the opening, sheet 30 will not pass through it. The width and length of sheet 30 may typically exceed the size of the opening by ½″ to 1-¼″ all around. That is, to yield a 1-inch lap all around, the overall dimension of sheet 30 would be 2″ larger than the opening in total. In one embodiment, the overlap is about 9/16″, so the total dimension is 1-⅛″ greater than the opening.

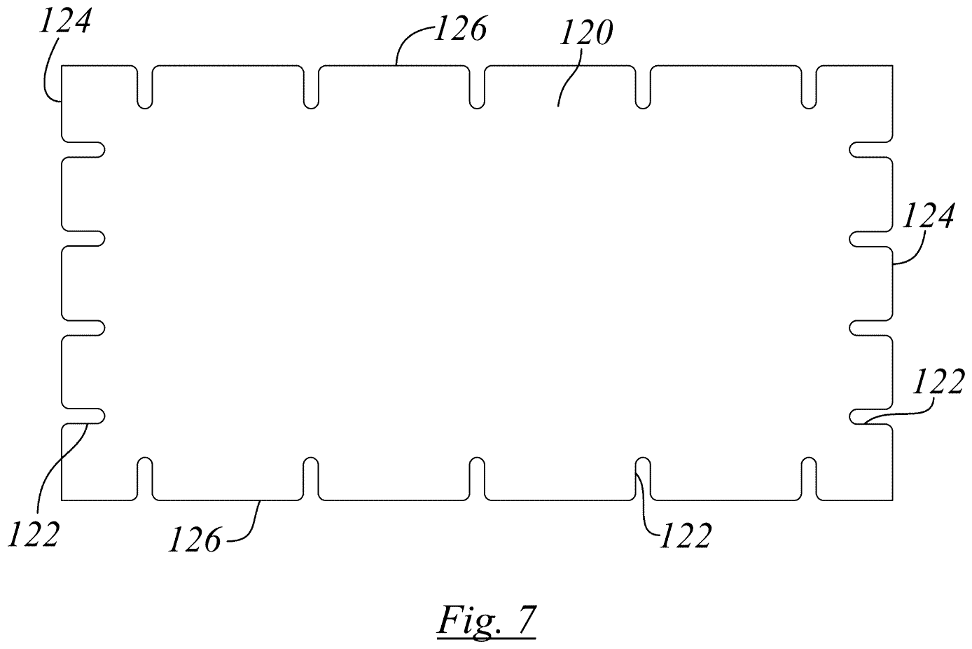

In FIG. 7 there is a glazing sheet or spanning sheet 120 that may be taken as being the same as glazing sheet or spanning sheet 30. It differs from spanning sheet 30 in that rather than having fastener accommodations defined by through holes in the nature of apertures 102, glazing sheet, or spanning sheet, 120 has fastener accommodations defined by rebates or reliefs 122 spaced along short and long edges 124, 126 to provide a clearance for protrusions 100.

As can be understood, the footprint of spanning sheet 30 is a rectangle defined by opposed pairs of edges 106, 108. That footprint is the same as the rectangular periphery of spanning sheet 30, which is the same as the circumscribed boundary of spanning sheet 30, i.e., the boundary that would be obtained by wrapping a string around edges 106, 108, and pulling it tight. By contrast, the footprint of spanning sheet 130 covers the same area as the footprint of spanning sheet 30, less the area of reliefs 122. It can be understood that the footprint of spanning sheet 120 overlaps webs or flanges 58 and overlaps both the width and length of the opening in the supporting structure by the same dimensional amount as spanning sheet 30, except that edges 124, 126 of spanning sheet 120 are segmented between successive pairs of reliefs 122. It may be noted that the circumscribed boundary of spanning sheet 120 is the same as the circumscribed boundary of spanning sheet 30. Unlike spanning sheet 30, parts of the periphery of sheet 120, namely the interior portions of reliefs 122, lie within the periphery defined by the opening in the supporting structure, or, alternatively, defined by the periphery of the insert web or flange 58, and parts of the periphery of spanning sheet 120 lie outside that periphery.

Looked at from another viewpoint, another circumscribed boundary can be defined in the x-y plane by wrapping a string tightly around the array of fasteners, or, indeed, around the array or protrusions 100. That circumscribed boundary can be termed the fastening boundary, or fastening footprint. As may be noted, in the case of spanning sheet 120, and as in the case of spanning sheet 30, the circumscribed boundary of the spanning sheet overlaps the fastening boundary in both the length and width dimensions. Further, it overlaps the fastening boundary (and the periphery of web or flange 58, and the opening in the supporting structure) on all sides. Whether for spanning sheet 30 with its straight edges, or for spanning sheet 120 with its segmented edges, the point is that the spanning sheet is too large to be drawn through the opening. In each case, whether the fastener accommodations are through holes or merely reliefs formed inwardly of the panel edges, the fasteners traverse the spanning sheet, notwithstanding that the fasteners lie within the circumscribed boundary of the spanning sheet.

Since the spanning sheet overlaps the supporting structure, when impact occurs due to contact from external objects, the force received by the spanning sheet, be it glazing sheet 30 or glazing sheet 120, is carried into the surrounding supporting structure, as opposed to being resisted solely by the strength of the connecting fasteners and the half-frame moldings.

Spanning sheet 30 sits in the accommodation in outside half frame 24. When spanning sheet 30 is seated there is mutual registration of the respective male and female indexing or keying members, namely protrusions 100 and apertures 102 upon each other. The sub-assembly is positioned in place in the opening in supporting structure 18. Fastening hardware 42 is introduced through openings or apertures 44 in back 66 of channel section 60 with the tips of hardware being advanced into blind bores 104. Fastening hardware 42 is then tightened to secured half frames 22 and 24 in place relative to each other with spanning sheet 30 captured in place. As so captured, spanning sheet 30 then covers the opening in supporting structure 18.

In summary, then, there is a window frame assembly 20 for mounting a window relative to an opening in a supporting structure 18. Window frame assembly 20 has a first half-frame 22, a second half-frame 24, and a glazing sheet 30. First half-frame 22 and second half-frame 24 are co-operable to form a full frame. First half frame 22 is an inner half-frame. Second half frame 24 is an outer half frame. The full frame has an accommodation 112 in which to receive glazing sheet 30. Glazing sheet 30 has a span that is larger than a corresponding span of the opening in the supporting structure 18.

The opening in supporting structure 18 has a height and a width. Glazing sheet 30 has a height and a width. Both (a) the width of glazing sheet 30 is greater than the width of the opening and (b) height of glazing sheet 30 is greater than the height of the opening. Glazing sheet 30 has a footprint that spans the opening in supporting structure 18 in at least one direction. The opening in the supporting structure 18 has a periphery. Glazing sheet 30 has a footprint, and, as installed, the footprint extends beyond the periphery of the opening in at least two opposed locations. The footprint overlaps the opening in supporting structure 18 on all sides. The opening has a periphery. Glazing sheet 30 has a periphery. As installed, glazing sheet 30 overlaps the opening in the supporting structure and all portions of the periphery of glazing sheet 30 lie outside the periphery of the opening in supporting structure 18.

Fasteners 42 secure first half-frame 22 and second half-frame 24 together. Glazing sheet 30 has accommodations 102 or 122 formed therein to permit fasteners 42 to traverse glazing sheet 30. In one example, the accommodations are bores 102 made through glazing sheet 30. Glazing sheet 30 has a set of edge reliefs 122 formed therein. Edge reliefs 122 define the accommodations for fasteners 42 and protrusions 100.

As described, there is a window frame assembly 20 for mounting a window relative to an opening in a supporting structure 18. Window frame assembly 20 has a first half-frame 22, a second half-frame 24, and a glazing sheet 30. On installation, first half-frame 22 and second half-frame 24 are secured to each other by fasteners 42. Glazing sheet 30 has accommodations formed therein to permit fasteners 42 to traverse glazing sheet 30.

The accommodations may be bores 102 made through glazing sheet 30. The accommodations may be reliefs 122 formed in glazing sheet 120. Glazing sheet 30 spans the opening in the supporting structure in both x and y directions. Glazing sheet 30 overlaps the opening in the supporting structure on all sides. Glazing sheet 30 overlaps all portions of the periphery of the opening in the supporting structure. A boundary of glazing sheet 30 is defined by the shortest line that circumscribes glazing sheet 120. The boundary of glazing sheet 120 spans the opening in the supporting structure. Fasteners 42 traverse glazing sheet 30 at locations inset from the boundary. First half-frame 22 is an inner half-frame. It has a peripherally extending flange 52 that, on installation, engages an inner face of supporting structure 18 and a peripheral web 58 that extends at least part way through supporting structure 18 away from peripherally extending flange 52 toward second half-frame 24. Second half-frame 24 is an outer half frame that has a peripherally extending flange 82 that engages an external face of supporting structure 18. The accommodations in glazing sheet 30, 120 lie inwardly of peripheral web 58. Fasteners 42 traverse glazing sheet 30 inwardly of peripheral web 58. Glazing sheet 30 has a circumscribed boundary that lies outside peripheral web 58.

Further, in this description there is a window frame assembly 20 for installation in an opening in a supporting wall structure 18. Window frame assembly 20 has a first half-frame 22, a second half frame 24, and a spanning sheet 30. First half-frame 22 is an inside half frame, and second half frame 24 is a mating outside half-frame. First half-frame 22 and the second half frame 24 are mutually co-operable on installation to define a full frame. The full frame has a glazing accommodation 112 defined therein in which spanning sheet 30 seats. Window frame assembly 20 has a spanning sheet. Spanning sheet 30 is at least partially translucent. Outside half frame 24 defines a retaining periphery 110 that is smaller than inside edge of the array of protrusions 100. Spanning sheet 30 is larger than retaining periphery 110.

As noted, spanning sheet 30 may not be merely translucent, but may be transparent. The full frame includes at least a first frame index 100 and spanning sheet 30 has at least a first sheet index 102. First frame index 100 and the first sheet index 102 are mutually engaging which inhibits release of spanning sheet 30 relative to the full frame. Outside half frame 24 has at least a first protrusion 100 defining the first indexing member. First protrusion 100 is a first attachment boss or stud and, on installation fastening hardware 42 engages the boss to secure inside half frame 22 to outside half frame 24. Outside half frame 44 has a set of protrusions 100 extending therefrom toward inside half frame 22, and spanning sheet 30 has a corresponding set of protrusion allowances 102 formed therein. Protrusion allowances 102 seat on protrusions 100 on installation of spanning sheet 30 relative to outside half frame 24. Spanning sheet 30 has a thickness, tₛₕₑₑₜ; and protrusions 100 have a length that is greater than the sum of tₛₕₑₑₜ. The set of protrusions 100 define attachment bosses that, on assembly, receive fastening hardware 42 to secure inside half frame 22 in position relative to outside half frame 24.

Inside half frame 22 includes a peripherally extending formed channel section 60 that has toes 64, 66 facing toward outside half frame 24. The toes include an outer peripheral toe 64 and an inner peripheral toe 66. Outside half frame 24 has a set of protrusions 100 extending therefrom toward inside half frame 22. Protrusions 100 define attachment bosses that, on installation, are engaged by fastening hardware 42 that secures inside half frame 22 in position relative to outside half-frame 24. As installed, the attachment bosses have tips that may register within formed channel section 60, and, in any case, lie in the z-direction projection of channel section 60. Channel section 60 has a back 62. On installation, fastening hardware 42 works against back 62 of channel section 60 to draw outside half frame 24 and inside half frame toward each other. Spanning sheet 30 is typically a polycarbonate sheet that is ¼″ thick.

Inner half frame 22 has a first abutment flange 52 that, on installation, bears against an inside face of supporting structure 18. Inner half frame 22 has an insertion flange or leg 58 that locates within the opening in supporting wall structure 18 and extends from abutment flange 52 of inner half frame 22 toward outside half frame 24. Insertion flange 58 has at least first and second opposed portions that define a first span dimension as represented by either of x₅₈ or y₅₈. Spanning sheet 30 spans at least the first span dimension and would typically span both directions. Outside half-frame 24 has a surround that has a periphery that lies fully outside the periphery of flange 58. The outside surround defines a trim molding of outside half-frame 24 and, in use, bears against an outside of the supporting wall structure to which window frame assembly 20 is mounted. Outside half-frame 24 has a boundary portion, namely leg 82, of a first thickness and a spanwise extending portion, namely leg 84, extending inwardly from boundary portion 82. Spanwise extending portion 84 is of a second thickness. The second thickness is less than the first thickness such that a recess 112 is defined laterally inwardly of boundary portion 82. Spanning sheet 30 is sized to seat in recess 112. Spanning sheet 30 has a through-thickness. Recess 112 has a depth corresponding to the through-thickness of spanning sheet 30. Spanning sheet is a polymeric sheet. Spanning sheet is a polycarbonate thermoplastic.

The embodiments illustrated and described above illustrate individual non-limiting examples in which the principles of the present invention are employed. It is possible to make other embodiments that employ the principles of the invention and that fall within the following claims. To the extent that the features of those examples are not mutually exclusive of each other, the features of the various embodiments may be mixed-and-matched, i.e., combined, in such manner as may be appropriate, without having to resort to repetitive description of those features in respect of each possible combination or permutation. The invention is not limited to the specific examples or details which are given by way of illustration herein, but only by the claims, as mandated by law. The claims are to be given the benefit of purposive interpretation to include equivalents under the doctrine of equivalents.

Although the various embodiments have been illustrated and described herein, the principles of the present invention are not limited to these specific examples which are given by way of illustration, but only by a purposive reading of the claims.

We claim:

1. A window frame assembly for mounting a window relative to an opening in a supporting structure, wherein said window frame assembly comprises:
a first half-frame, a second half-frame, and a glazing sheet;
said first half-frame and said second half-frame being co-operable to form a full frame;
said first half frame being an outer half-frame;
said second half frame being an inner half frame;
said full frame having an accommodation in which to receive said glazing sheet; and
said glazing sheet having a span that is larger than a corresponding span of the opening in the supporting structure.

2. The window frame assembly of claim 1, the opening in the supporting structure having a height and a width, and wherein said glazing sheet has a height and a width, and one of (a) said width of said glazing sheet is greater than the width of the opening; and (b) said height of the glazing sheet is greater than the height of the opening.

3. The window frame assembly of claim 1, the opening in the supporting structure having a height and a width, and wherein said glazing sheet has a height and a width, and both (a) said width of said glazing sheet is greater than the width of the opening; and (b) said height of the glazing sheet is greater than the height of the opening.

4. The window frame assembly of claim 1 wherein said glazing sheet has a footprint and said footprint overspans the opening in the supporting structure in at least one direction.

5. The window frame assembly of claim 1, the opening in the supporting structure having a periphery, and wherein the glazing sheet has a footprint, and, as installed, said footprint extends beyond the periphery of the opening in at least two opposed locations.

6. The window frame assembly of claim 5 wherein, as installed, said footprint overlaps the opening in the supporting structure on all sides.

7. The window frame assembly of claim 1, the opening in the supporting structure having a periphery, and wherein the glazing sheet has a periphery, and, as installed, said glazing sheet overlaps the opening in the supporting structure and all portions of said periphery of said glazing sheet lie outside the periphery of the opening in the supporting structure.

8. The window frame assembly of claim 1, wherein fasteners secure said first half-frame and said second half-frame together, and said glazing sheet has accommodations formed therein to permit said fasteners to traverse said glazing sheet.

9. The window frame assembly of claim 8 wherein said accommodations are bores made through said glazing sheet.

10. The window frame assembly of claim 8 wherein said glazing sheet has a set of edge reliefs formed therein, said edge reliefs defining said accommodations for said fasteners.

11. A window frame assembly for mounting a window relative to an opening in a supporting structure, wherein said window frame assembly comprises:
a first half-frame, a second half-frame, and a glazing sheet;
on installation, said first half-frame and said second half-frame being secured to each other by fasteners; and
said glazing sheet having accommodations formed therein to permit said fasteners to traverse said glazing sheet.

12. The window frame assembly of claim 11 wherein said accommodations are bores made through said glazing sheet.

13. The window frame assembly of claim 11 wherein said glazing sheet has a set of edge reliefs formed therein, said edge reliefs defining said accommodations for said fasteners.

14. The window frame assembly of claim 11 wherein, as installed, said glazing sheet spans the opening in the supporting structure in at least one direction.

15. The window frame assembly of claim 14 wherein, as installed, said glazing sheet spans the opening in the supporting structure in at least a first direction and a second direction, the second direction being transverse to the first direction.

16. The window frame assembly of claim 11 wherein, as installed, said glazing sheet overlaps the opening in the supporting structure on all sides.

17. The window frame assembly of claim 11 wherein the opening in the supporting structure has a periphery, and said glazing sheet overlaps all portions of the periphery of the opening in the supporting structure.

18. The window frame assembly of claim 11 wherein a boundary of said glazing sheet is defined by the shortest line that circumscribes said glazing sheet; and said boundary of said glazing sheet spans the opening in the supporting structure.

19. The window frame assembly of claim 11 wherein a boundary of said glazing sheet is defined by the shortest line that circumscribes said glazing sheet; and said fasteners traverse said glazing sheet at locations inset from said boundary.

20. The window frame assembly of claim 11 wherein:
said glazing sheet is a polycarbonate sheet;
said first half-frame is an inner half-frame; and said first half frame has a peripherally extending flange that, on installation, engages and inner face of the supporting structure, and a peripheral web that extends at least part way through the supporting structure away from said peripherally extending flange toward said second half-frame;
said second half-frame is an outer half frame that has a peripherally extending flange that, on installation, engages an external face of the supporting structure;
said accommodations in said glazing sheet lie inwardly of said peripheral web;
said fasteners traverse said glazing sheet inwardly of said peripheral web; and
said glazing has a circumscribed boundary that lies outside said peripheral web.
